(19) United States
(12) Patent Application Publication
(10) Pub. No.: US 2003/0126466 A1
(43) Pub. Date: Jul. 3, 2003

(54) Method for controlling an internet information security system in an IP packet level

(76) Inventors: So-Hee Park, Daejeon (KR); Ji Hoon Jeong, Daejeon (KR); Hyung Kyu Lee, Daejeon (KR); Gunwoo Kim, Daejeon (KR); Su Hyung Jo, Daejeon (KR); Won-Joo Park, Daejeon (KR); Jae Hoon Nah, Daejeon (KR); Sung Won Sohn, Daejeon (KR); Chee Hang Park, Daejeon (KR)

Correspondence Address: JACOBSON HOLMAN PLLC, 400 SEVENTH STREET N.W., SUITE 600, WASHINGTON, DC, 20004, US

(21) Appl. No.: 10/188,110

(22) Filed: Jul. 3, 2002

(30) Foreign Application Priority Data
Dec. 28, 2001 (KR) 2001-86983

(51) Int. Cl. H04L 9/00

(52) U.S. Cl. 713/201

(57) ABSTRACT

A method for controlling an Internet information security system of a sender, for packet security in an IP level, is provided. It is determined whether to select security services of packets by referring to security policy database and security association database. Security association is negotiated with a key exchange server of a receiver. The negotiated security association is stored in a key management server. A security policy related with the security association is linked. A packet is sent by using the linked security policy and the security association.

### FIELD OF THE INVENTION

The present invention relates to an implementation method of an IPSEC (IP security protocol) for packet security in an IP level in order to provide, control, manage and evaluate an information security service on the Internet, and a program configuration therefor.

### BACKGROUND OF THE INVENTION

Conventional Internet information security technologies are methods for performing information security on the basis of services of application layers. These methods design techniques of information security for users on the basis of each service of application layers, wherein the designed techniques are used by employing a direct call in a service program of each application layer. These conventional methods for Internet information security mean that there are information security methods on the basis of Internet services and that a change of an application layer service program is necessary in order to provide information security in Internet services. This entails heavy financial expenditure for users and Internet service providers. Besides, there are needed respective independent information security methods corresponding to each application layer service and additional changes of each application layer service program.

### SUMMARY OF THE INVENTION

It is, therefore, an object of the present invention to provide a method for providing, controlling, managing and evaluating multiple information security services on a packet basis in an IP level that is capable of realizing an independent implementation and operation without affecting an application layer service program, instead of methods for performing information security on the basis of services of application layers, which are used in conventional Internet information security technologies.

Since an IPSEC (IP security protocol) technology of the present invention provides an information security service on a packet basis in an IP level, the independent implementation and operation are possible without affecting an application layer service program. Also, information security of all Internet services without changing application layer programs and a process of a general IP packet that does not need an information security service become possible. Besides, conventional Internet users do not recognize any changes in using Internet services. Moreover, in comparison with conventional methods for packet security of an IP level, at least one security service can be applied to an IP packet through a control block.

In accordance with a preferred embodiment of the present invention, there is provided a method for controlling an Internet information security system of a sender in order to secure a packet in an IP level, including the steps of:

(a) determining whether to select a security service on a packet basis by referring to security policy database and security association database, after generating an IP header of a packet that is intended to send;

(b) setting up a security policy by negotiating with a security policy control server of a receiver, when the security policy database and the security association database do not exist;

(c) negotiating security association with an Internet key exchange server of the receiver, based on the determined security policy;

(d) storing the negotiated security association in a key management server;

(e) linking a security policy related with the security association; and

(f) sending the packet by applying IPsec (IP security protocol) and using the linked security policy and the security association.

In accordance with another preferred embodiment of the present invention, there is provided a method for controlling an Internet information security system of a receiver, for packet security in an IP packet, including the steps of:

(g) determining a security service on a packet basis with reference to security association database, after reassembling a received packet and receiving the reassembled packet;

(h) removing an information security service that is applied to the packet by using the referred security association database; and

(i) inquiring a security policy server in order to confirm that the applied information security service corresponds to the security policy of the receiver.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram to show a structure of an Internet information security control system in order to provide, control, manage and evaluate a packet security service in an IP packet level in accordance with the present invention;

FIG. 2A is a block diagram of an IP security connection host system of the Internet information security control system illustrated in FIG. 1;

FIG. 2B is a block diagram of an IP security connection gateway system of the Internet information security control system illustrated in FIG. 1;

FIG. 2C is a block diagram of an IP security connection control system of the Internet information security control system illustrated in FIG. 1;

FIG. 3A illustrates a process of a packet security service in an IP level of a sender in accordance with the present invention;

FIG. 3B represents a process of a packet security service in an IP level of a receiver in accordance with the present invention;

FIGS. 4A and 4B provide an entire process of a packet security service in an IP level in accordance with the present invention;

FIG. 5A shows a function of a security host block of an IP security connection host system in accordance with the present invention;

FIG. 5B depicts a function of a security gateway block of the IP security connection gateway system in accordance with the present invention;

FIG. 5C presents a function of an Internet key management block of the IP security connection host system or an IP security connection gateway system in accordance with the present invention;

FIG. 5D offers a function of an Internet key exchange block of the IP security connection host system or the IP security connection gateway system in accordance with the present invention;

FIG. 5E illustrates a function of a security policy control block of an IP security connection control system in accordance with the present invention; and

FIG. 5F shows a function of a security management block of the IP security connection control system in accordance with the present invention.

### DETAILED DESCRIPTION OF THE PREFERRED EMBODIMENTS

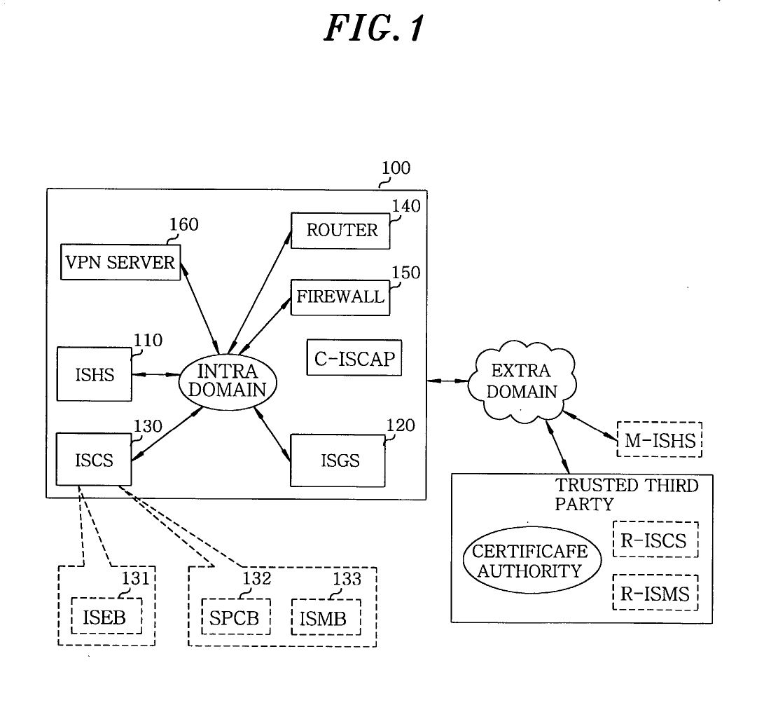

Referring to FIGS. 1 to 5F, preferred embodiments of the present invention will be described in detail.

FIG. 1 illustrates an Internet information security control system 100 employing a controlling method thereof in accordance with the present invention.

The information security control system 100 in accordance with the present invention includes an IP security connection host system (ISHS) 110, an IP security connection gateway system (ISGS) 120 and an IP security connection control system (ISCS) 130. An IP packet is sent/received in the IP security connection host system 110, and this is forwarded to another system through the IP security connection gateway system 120. The IP security connection control system 130, which controls an information security service applied to an IP packet that is sent/received, is composed of a security policy control block (SPCB) 132, an Internet security management block (ISMB) 133 and an Internet security evaluation block (ISEB) 131. These blocks may be implemented in one system or may be realized each server to each other. And these blocks may be realized in different structures to each other. The Internet information security control system 100 can cooperate with a router 140 that IPsec is applied, a firewall 150 and a VPN server 160, and also can exchange information about public key authentication through a cooperation with CA that is provided by a public key-based system.

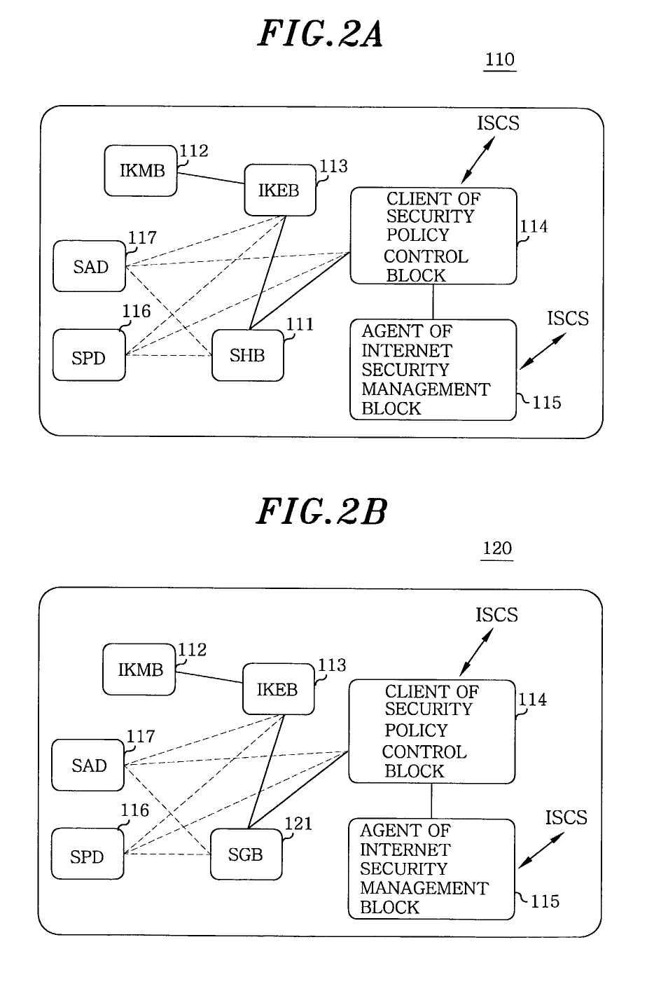

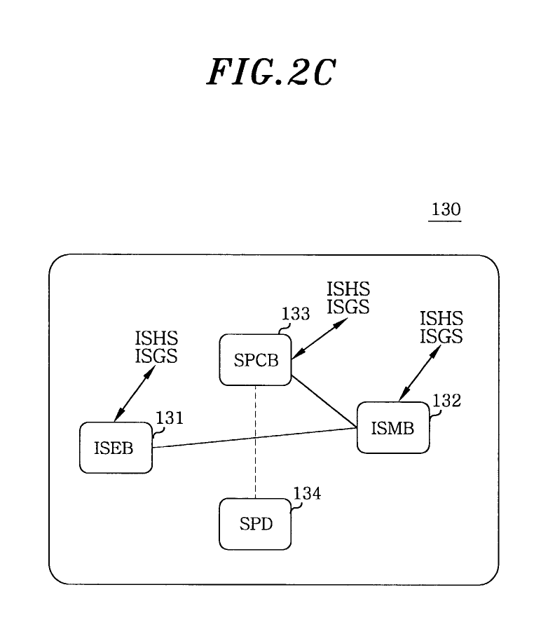

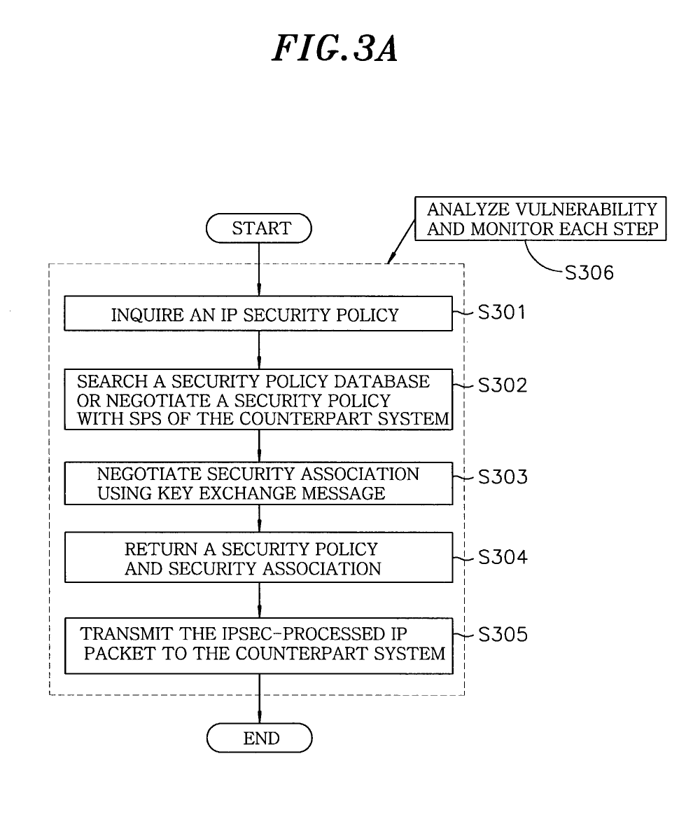

FIGS. 2A to 2C show block diagrams of an IP security connection host system 110, an IP security connection gateway system 120 and an IP security connection control system 130, respectively, which are sub-systems of the Internet information security control system 100.

The IP security connection host system 110 of FIG. 2A has a security host block (SHB) 111, an Internet key management block (IKMB) 112, an Internet key exchange block (IKEB) 113, a client of a security policy control block 114, an agent of an Internet security management block 115, security policy database (SPD) 116 and a security association database (SAD) 117.

The IP security connection gateway system 120 of FIG. 2B has the same configuration as the IP security connection host system 110, but has a security gateway block (SGB) 121 instead of the security host block (SHB) 111.

The security connection control system 130 of FIG. 2C includes a security policy control block (SPCB) 133, a manager of an Internet security management block (ISMB) 132, an Internet security evaluation block (ISEB) 131 and a security policy database (SPD) 134.

The IP security connection host system 110 and the IP security connection gateway system 120 provide information security services such as confidentiality, connectionless integrity, access control, data origin authentication, partial anti-replay attack and limited traffic flow confidentiality services of data to an IP packet that is sent/received in a host or forwarded from a gateway. The IP security connection gateway system 120 is cooperated with the router 140, the firewall 150 and the VPN server 160. The IP security connection control system 130, which provides a perfect information security service on Internet and controls/monitors Internet entities such as each host and gateway, has a role of controlling components of each system. Also, the system 130 performs a set up of an security policy and an information exchange for secure end-to-end communication such as between a host to a host, a host and a gateway, and a gateway and a gateway. Moreover, through an analysis of security vulnerability of components, an auditing event handling, and a monitoring of a system and IP data, security problems can be found and reported to an administrator so that a security administrator can solve these problems.

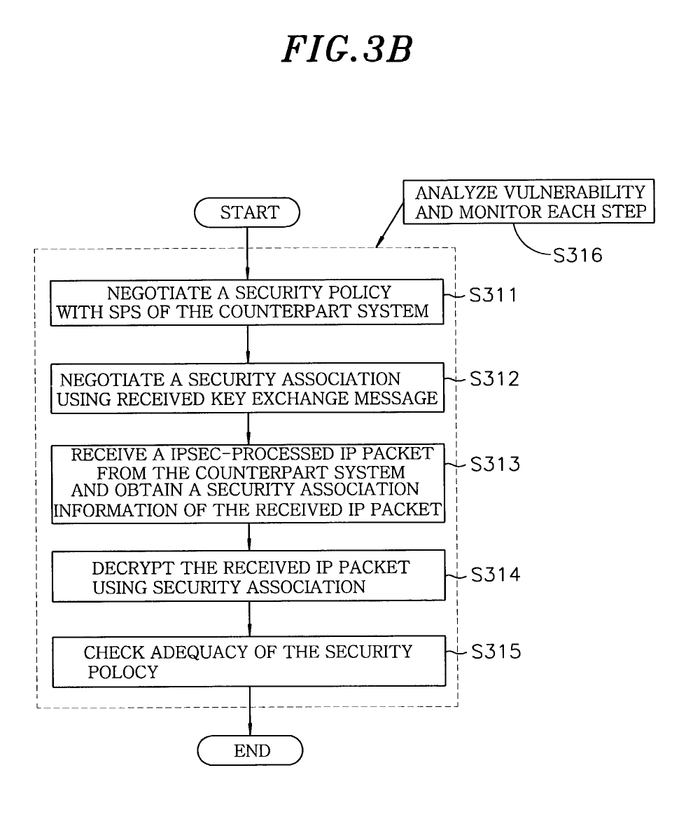

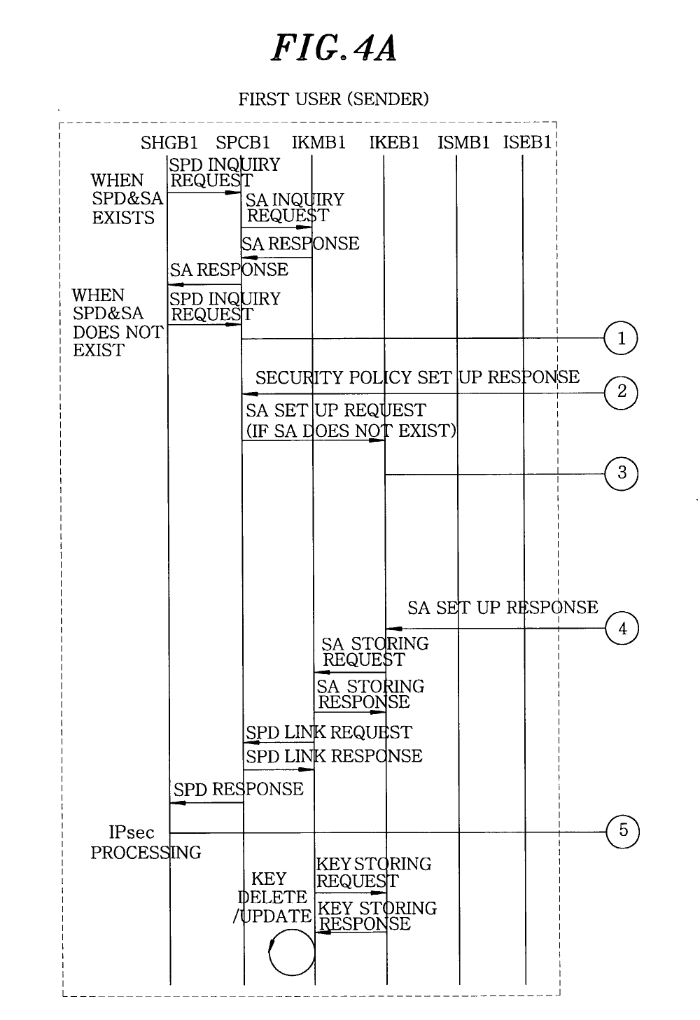

FIG. 3A represents a processing procedure of an outbound IP packet for providing and controlling information security on a packet basis. FIG. 3B presents a processing procedure of an inbound IP packet that information security services are provided.

The outbound packet process illustrated in FIG. 3A is performed by two modes, i.e., a tunnel mode and a transport mode, based on a security policy. The tunnel mode is performed when the IP security connection gateway system 120 joins in a security process of an IP packet. In the transport mode, only the IP security connection host system 110 performs a security process to an IP packet, and the IP security connection gateway system 120 also undertakes a transmission of the IP packet.

A more detailed description for the procedure of the outbound packet process illustrated in FIG. 3A is as follows. First, the IP security connection host/gateway system 110/120 requests the IP security connection control system 130 to inquire an IP security policy (step S301). In response to this request, the IP security connection control system 130 searches its database and if not exist, starts to negotiate a security policy with the IP security connection control system 130 of the counterpart system (step S302). Next, the IP security connection host/gateway system 110/120 generates a key exchange message and negotiates the security association (step S303). And the IP security connection control system 130 transmits a corresponding result to the IP security connection host/gateway system 110/120 and IP security connection host/gateway system 110/120 perform a security processing to the output IP packet (step S304). Then IP security connection host/gateway system 110/120 transmits the IPsec-processed IP packet to the IP security connection host/gateway system 110/120 in the counterpart system (step S305). Also the IP security connection control system 130 analyzes a security vulnerability in offline each block and monitors each step (step S306).

The inbound packet process illustrated in FIG. 3B is different from the outbound packet process shown in FIG. 3A. When receiving a security-processed IP packet, first, a process to an IP security packet is performed, and then it is checked whether a related security policy is properly applied or not. However, both modes are performed in the same manner as in the outbound packet process. Through the processing procedure above, an integrated management monitoring and an analysis of security vulnerability are performed.

A more detailed description for the procedure of the inbound packet process illustrated in FIG. 3B is as follows. First, when receiving a security policy negotiation message, the an IP security connection control system 130 takes part in negotiating with an IP security connection control system 130 in the counterpart system (step S311) and when the key exchange messages was received, the IP security connection host/gateway system 110/120 generate the SA using received messages (step S312). Then if receiving an IPsec-processed IP packet, it is checked whether a security is applied or not and obtains a security association information from the received IP packet (step S313).

Next, the IP security connection host/gateway system 110/120 decrypt the received IPsec-processed IP packet using obtained security association (step S314). And the IP security connection host/gateway system 110/120, which decrypt the IP packet, request the IP security connection control system 130 to inquire the IP security policy and the IP security connection control system 130 checks adequacy of the security policy that is applied to the received IP packet (step S315). Also the IP security connection control system 130 analyzes a security vulnerability in offline each block and monitors each step like the outbound packet procedure (step S316).

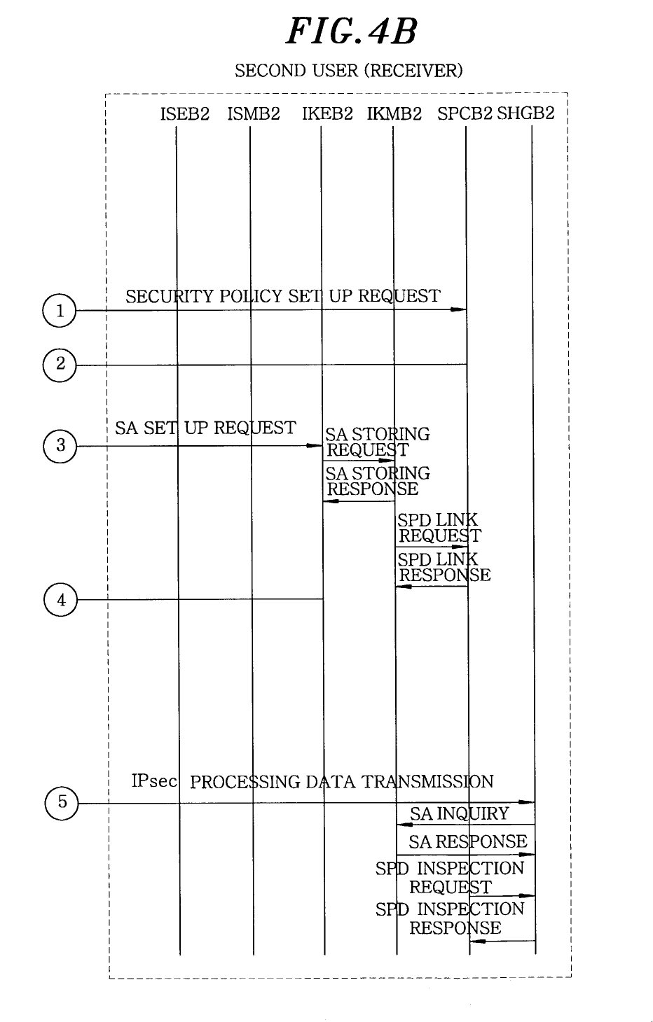

FIGS. 4A and 4B describe an overall process for controlling an Internet information security system in accordance with the present invention. In FIGS. 4A and 4B, numbers 1 and 2 attached to names representing each block (SHGB, SPCB and so on) describe a sender and a responder respectively, which are counterparts of a currently performing communication (e.g. SHGB1 and SHGB2). Besides, among the block names, SHGB represents either one of the security host block (SHB) 111 of the IP security connection host system 110 or the security gateway block (SGB) 121 of the IP security connection gateway system 120.

As illustrated in FIGS. 4A and 4B, a first user (sender) generates an IP header of a packet to be sent and determines whether to select a security service on a packet basis with reference to security policy database (SPD) and security association (SA). If the security policy database (SPD) and the security association (SA) do not exist, a security policy between a security policy control block (SPCB1) of the first user (sender) and a security policy control block (SPCB2) of a second user (responder) is set up by a negotiation. The security association based on the negotiated security policy is negotiated with an Internet key exchange block (IKEB2) of the second user. The second user sends the negotiated security association (SA), the first user stores the received SA, and links a security policy database related to the security association. So a security policy control block (SPCB1) returns a security policy to a security host/gateway block (SHGB). After finishing generating a security policy and security association, the first user determines whether to select a security service on a packet basis with reference to a security association database (SAD). By using the referred security association database (SAD), the first user transmits an IP packet, which is applied the IPsec.

The second user stores the determined security association (SA) in the Internet key management block (IKMB2), and at the same time links a security policy database (SPD) related to the security association (SA). If the first user sends data by applying IPsec with the security association (SA), the second user receives a packet that an information security service is applied, and reassembles the received packet. After receiving a reassembled IP packet, the second user obtains a security association information on a packet basis. By using the referred security association database (SAD), IPsec service of a packet is released, and a security policy control block (SPCB2) is inquired whether the applied information security service corresponds to a security policy.

When the security association database is expired, an Internet key management block (IKMB1) negotiates and stores new security association (SA), and deletes and renews a key by requesting an Internet key exchange block (IKEB1) to generate the new security association (SA). A security management manager and an agent in each level monitor database and a packet of a system block, and report auditing events to a security administrator server. Also, they evaluate a security service, and analyze security vulnerability by intruding each block in offline.

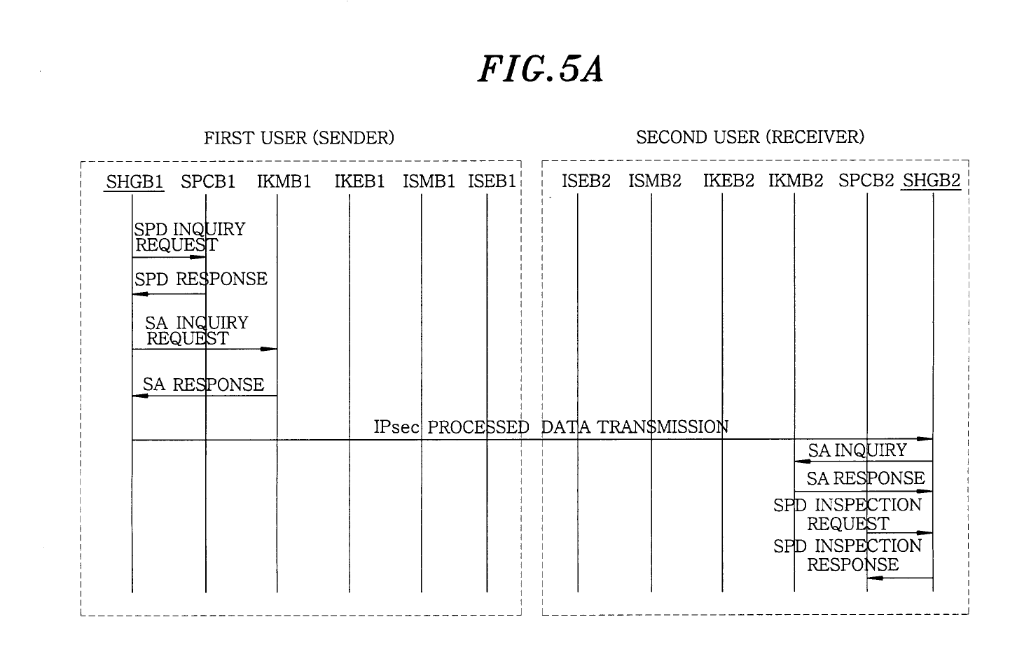

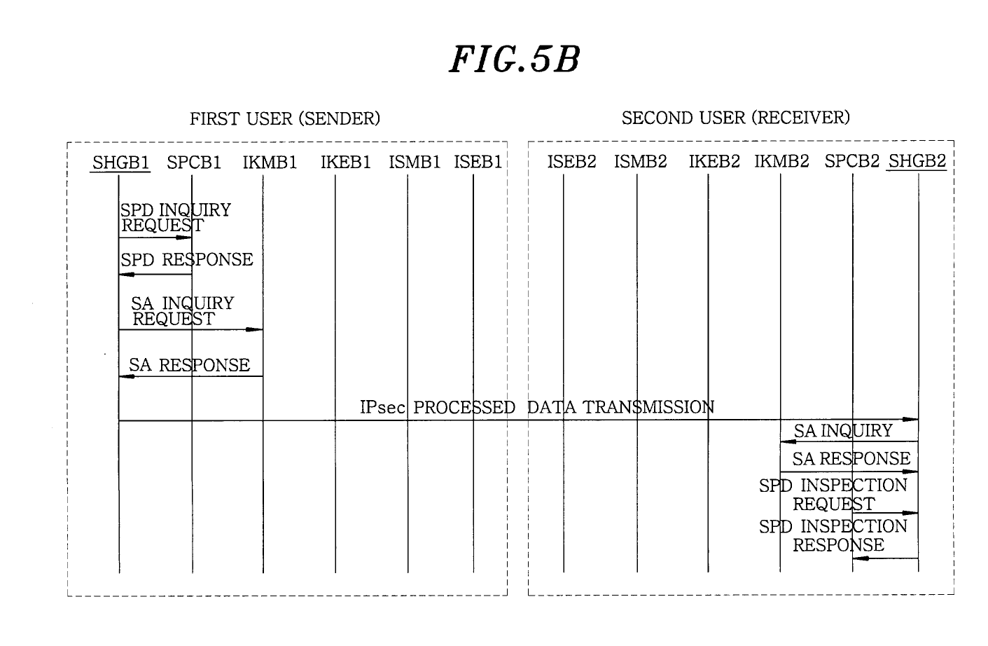

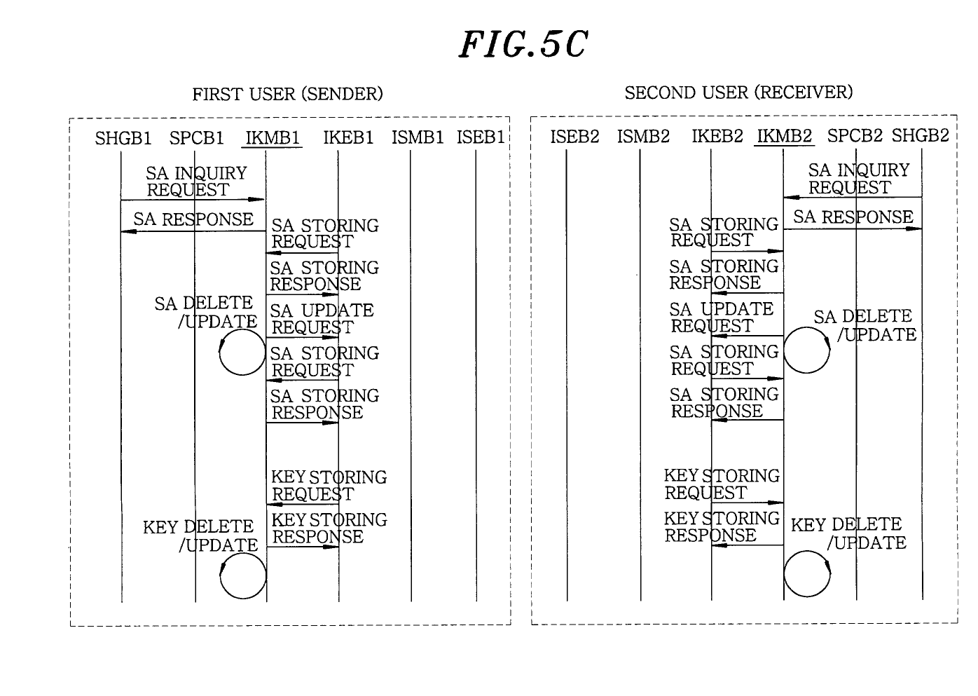

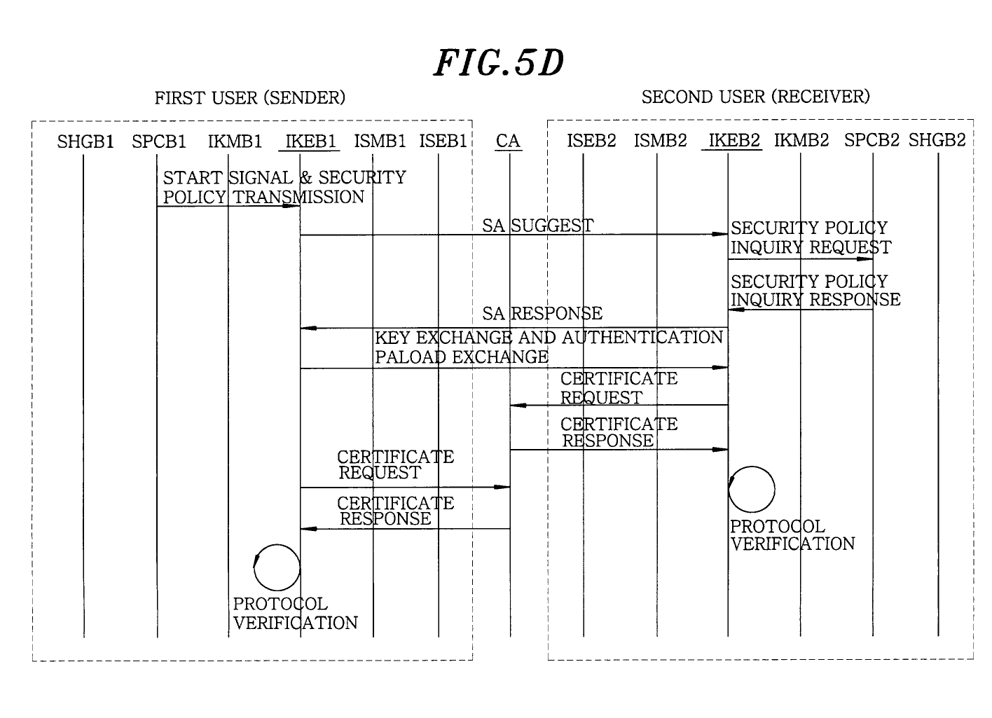

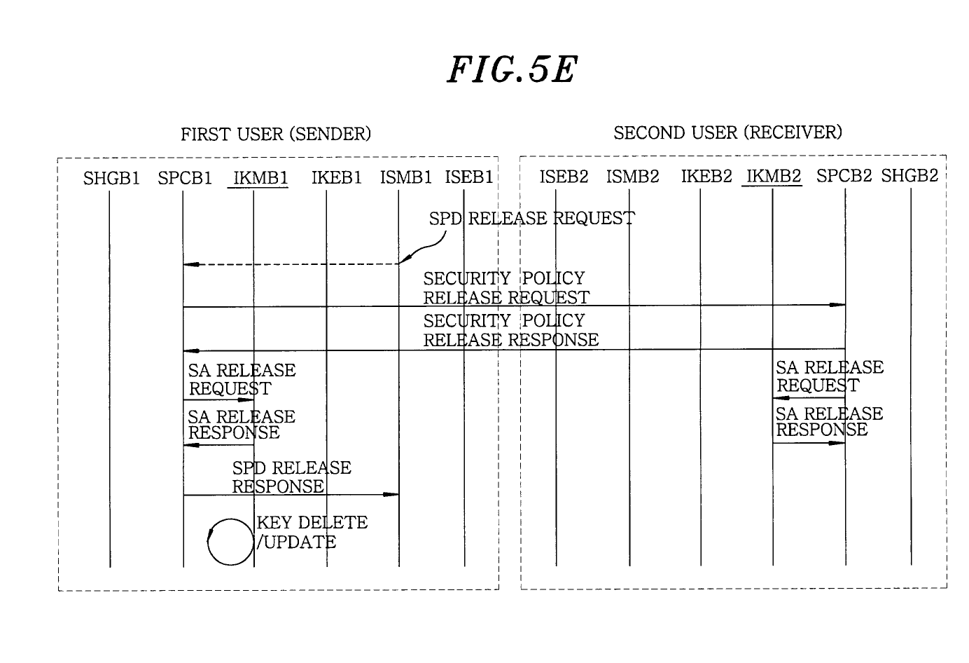

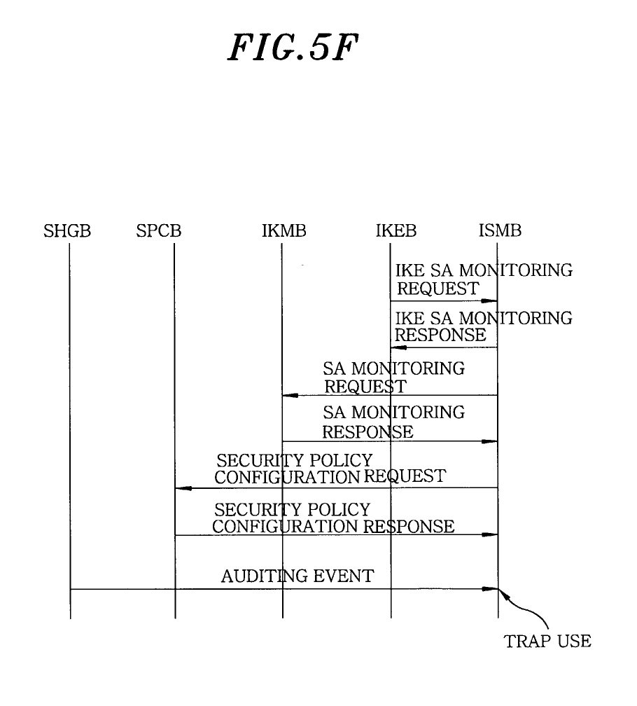

FIGS. 5A to 5F show performing processes of functions of each block for controlling an. Internet information security system in accordance with the present invention.

FIG. 5A depicts a function of a security host block 111 of the IP security connection host system 110, wherein the security host block 111 is indicated as SHB. The security host block (SHB) is operated with a security policy control block (SPCB), an Internet key management block (IKMB) and a security host block (SHB) of a communication counterpart, wherein an operating process of the security host block (SHB) is divided into an outbound message process and an inbound message process.

The outbound message process is performed as follows. First, a first user requests a security policy control block (SPCB1) to inquire a corresponding security policy of security policy database (SPD) for a security process of data to be sent. When the inquiry is completed, the security process to data to be sent is performed based on the security policy and the security association.

The inbound message process is performed as follows. A second user requests an Internet key management block (IKMB2) to inquire corresponding security association (SA) in order to recover data. When the inquiry is completed, a recovery of security process data based on the corresponding security association (SA) is performed. After the recovery of the security process data, a security host block (SHB2) requests to inquire a security policy database (SPD) entry in order to check whether an applied security policy is proper or not.

FIG. 5B illustrates a function of a security gateway block 121 of the IP security connection gateway system 110, wherein the security gateway block 121 is indicated as SGB. A function of the security gateway block (SGB) 121 illustrated in FIG. 5B is operated as a tunnel mode. The security gateway block (SGB) is operated with a security policy control block (SPCB), an Internet key management block (IKMB) and a security gateway block (SGB) of a communication counterpart for a security process of data. An operating process of the security gateway block (SGB) is as follows.

An outbound message process is performed as follows. A first user requests a security policy control block (SPCB1) to inquire a corresponding security policy of security policy database (SPD) for a security process of data to be sent. When the inquiry is completed, the security process is performed for the data to be sent based on the security policy and the security association.

An inbound message process is performed as follows. A second user requests an Internet key management block (IKMB2) to inquire corresponding security association database (SAD) in order to recover security process data. When the inquiry is completed, a recovery of the security process data based on corresponding security association (SA) is performed. After the recovery of the security process data, a security gateway block (SGB2) requests to inquire a security policy database (SPD) entry in order to check whether an applied security policy is proper or not.

FIG. 5C provides a key management function that is performed in an Internet key management block 112 of the IP security connection host system 110 or the IP security connection gateway system 120, wherein the Internet key management block 112 is indicated as IKMB. The Internet key management block (IKMB) performs a management of a key and a security association (SA) generated by an Internet key exchange block (IKEB). The Internet key management block (IKMB) is operated with a security policy control block (SPCB), an Internet key evaluation block (IKEB), a security host block and a security gateway block (SHGB) for a request to inquire the security association (SA), the key and connectivity with security policy database (SPD). An operating process of the Internet key management block (IKMB) is as follows.

An outbound message process is performed as follows. When a security policy control block (SPCB1) sends a request to inquire security association (SA) in order to return the security association (SA) that corresponds to a corresponding security policy, as a result of an inquiry of the security policy of the security host block or the security gateway block (SHGB1), an Internet key management block (IKMB1) responds with the corresponding security association (SA).

Also, the Internet key management block (IKMB1) manages the security association (SA) generated by a negotiation of an Internet key exchange block (IKEB1). Thus, whenever the Internet key exchange block (IKEB1) generates security association (SA), it replies a completed result about storing the security association (SA) with receiving a storing request of the corresponding security association (SA). When storing the corresponding security association (SA), a link request of the security association (SA) that is set up for a security policy control block (SPCB1) and a corresponding security policy database (SPD) entry is sent.

An inbound message process is performed as follows. When a security host block or a security gateway block (SHGB2) of a second user sends a request to inquire corresponding security association (SA) in order to recover a received security process message, an Internet key management block (IKMB2) responds with the corresponding security association (SA). Similarly, the Internet key management block (IKMB2) manages the security association (SA) generated by a negotiation. Therefore, whenever an Internet key exchange block (IKEB2) generates security association (SA), it receives a storing request of the corresponding security association (SA), and replies a completed result about storing the security association (SA) FIG. 5D shows an automatic key negotiation function that is performed in an Internet key exchange block 113 of the IP security connection host system 110 or the IP security connection gateway system 120, wherein the Internet key exchange block 113 is indicated as IKEB. The Internet key exchange block (IKEB) performs a negotiation of security association (SA) and a key in order to provide a security service to an IP packet. The negotiation of the security association (SA) and the key can use several authentication methods based on modes provided from the Internet key exchange block (IKEB). The Internet key exchange block (IKEB) is operated with a security policy control block (SPCB), an Internet key management block (IKMB) and an Internet key exchange block (IKEB) of a communication counterpart in order to negotiate the security association (SA) and the key associated with a security policy.

In order to make the security policy control block (SPCB) respond to an inquiry request of a security policy database (SPD) entry of a security host block or a security gateway block (SHGB), the corresponding security policy database (SPD) entry and security association (SA) therefor should exist. Consequently, if the corresponding security association (SA) does not exist, the Internet key exchange block (IKEB) should be activated by a request of the security policy control block (SPCB) for a security association negotiation. If an Internet key exchange block (IKEB1) of a first user is activated, an Internet key exchange block (IKEB2) of a second user is activated by sending a set up request of security association (SA) for negotiating the security association (SA). Thus, the security association (SA) is negotiated and set up between the Internet key exchange blocks (IKEB) of both communications. Furthermore, the Internet key exchange block (IKEB1) sends a storing request of security association (SA) to an Internet key management block (IKMB) for storing the determined security association (SA).

FIG. 5E illustrates a security policy set up function, which is performed in a security policy control block 133 of the IP security connection control system 130, wherein the security policy control block 133 is indicated as SPCB. The security policy control block (SPCB) is operated with a security host block or a security gateway block (SHGB), an Internet key management block (IKMB), an Internet key exchange block (IKEB) and a security policy control block (SPCB) of a communication counterpart in order to set up and release a security policy.

Besides, the SPCB 133 manually changes a set up of the security policy by configuring with an Internet security management block (ISMB). When there is a corresponding security policy database (SPD) entry, if the security host block or the security gateway block (SHGB) requests the security policy control block (SPCB) to inquire security policy database (SPD), the security policy control block (SPCB) requests the Internet key management block (IKMB) to inquire security association (SA). When receiving the security association (SA) from the Internet key management block (IMB), the security policy database (SPD) and security association (SA) entry are sent to a security host block or a security gateway block (SHGB).

When there is no corresponding security policy database (SPD) entry, if the security host block or the security gateway block (SHGB) requests to inquire security policy database (SPD), the security policy control block (SPCB) replies by setting up a security policy database (SPD) entry. If there is no corresponding security association (SA), the security association (SA) is received by requesting the Internet key exchange block (IKEB) to set up the security association (SA). If the Internet key management block requests a security policy database (SPD) link, the security policy control block (SPCB) replies the security policy database (SPD) link. Then, the security policy database (SPD) and the security association (SA) are sent to the security host block or the security gateway block (SHGB).

To check whether proper security policy database (SPD) is applied to the inbound message, an adequacy test of the security policy database (SPD) is requested to a security host block or a security gateway block (SHGB), and a reply is received. If an Internet security management block (ISMB) requests a release, a security policy control block (SPCB) releases the determined security policy database (SPD). After the security policy control block (SPCB) releases the security policy database (SPD), it requests an Internet key management block (IKMB) to release security association (SA). The Internet key management block (IKMB) removes the corresponding security association (SA) and a key, and the security policy control block (SPCB) reports a release of the security policy database (SPD) to the Internet security management block (ISMB).

FIG. 5F describes an integrated management monitoring function that is performed by an Internet security management block 132 of the IP security connection control system 130, wherein the Internet security management block 132 is indicated as ISMB. The integrated management monitoring function can be realized by a monitoring request of each function block by the Internet security management block (ISMB) and a reply process. The Internet security management block (ISMB) monitors security association (SA) that is generated and released by using a trap, and also monitors an IP packet of a security host block or a security gateway block (SHGB). Also, the ISMB 132 receives a report for a changed set up, an evaluation, security vulnerability by a security evaluation block (ISEB). Besides, the ISMB 132 shows a policy of a security policy control block (SPCB), manually configures a security policy, requests a configuration of SA to an Internet key management block (IKMB) and receives a reply.

Finally, a security vulnerability analysis function is performed by the Internet security evaluation block (ISEB) of the IP security connection control system 130. The Internet security evaluation block (ISEB) performs a related monitoring request in order to analyze security vulnerability of each function block, and also performs a vulnerability monitoring request of each function block and a reply process. Moreover, in real-time the ISEB monitors security vulnerability and a mistaken set up of a security host block or a security gateway block (SHGB), a security policy control block (SPCB), an Internet key management block (IKMB), an Internet key exchange block (IKEB) and an Internet security management block (ISMB). By analyzing them, the ISEB evaluates security of an overall network. The Internet security evaluation block (ISEB) collects network information when a usage of network is low, and reports to the Internet security management block (ISMB), which processes statistics. The Internet security evaluation block (ISEB) predicts an intrusion scenario, which can happen because of security problems, by using an analyzed result of collected information.

As described above, the present invention can provide multiple security services and information security services when a message generated from a higher application layer is changed into an IP packet that can be transmitted through Internet. Also, in accordance with the present invention, information security function can be provided to all Internet services without changing a higher-level application program. By employing an integrated control of a system, perfect information security services can be provided to Internet entities such as each host and gateway. Besides, an analysis of security vulnerability of components, an auditing event handling, and a monitoring of a system and IP data help to find security problems, and these are reported to an administrator so that a security administrator can solve the problems.

While the invention has been shown and described with respect to the preferred embodiments, it will be understood by those skilled in the art that various changes and modifications may be made without departing from the spirit and scope of the inventions as defined in the following claims.

What is claimed is:

1. A method for controlling an Internet information security system of a sender, in order to secure a packet in an IP level, comprising the steps of:
(a) determining whether to select a security service on a packet basis by referring to security policy database and security association database, after generating an IP header of a packet that is intended to send;
(b) setting up a security policy by negotiating with a security policy control server of a receiver, when the security policy database and the security association database do not exist;
(c) negotiating security association with a key exchange server of the receiver, based on the determined security policy;
(d) storing the negotiated security association in a key management server;
(e) linking a security policy related with the security association; and
(f) sending the packet by applying IPsec (IP security protocol) and using the linked security policy and the security association.

2. A method for controlling an Internet information security system of a receiver, for packet security in an IP packet, comprising the steps of:
(g) determining a security service on a packet basis with reference to security association database, after reassembling a received packet and receiving the reassembled packet;
(h) removing an IPsec service that is applied to the packet by using the referred security association database; and
(i) inquiring a security policy control server in order to confirm that the applied information security service corresponds the security policy of the receiver.

3. The method of claim 1, further comprising the step of:
(j) negotiating and storing the new security association database, and deleting and renewing a key, since a key management server requests a key exchange server to generate new security association database, when the security association database is expired.

4. The method of claim 1, further comprising the steps of:
(k) monitoring each function block of the Internet information security system and the packet in each step, which is performed by a security management manager and an agent, for providing a perfect information security service and an integrated control of components; and
(l) informing auditing events to a security management server, as a result of the monitoring.

5. The method of claim 1, further comprising the step of:
(m) evaluating a security service by intruding said each function block in offline, in order to analyze security vulnerability of each function block of the Internet information security system.
